(19) United States
(12) Patent Application Publication
(10) Pub. No.: US 2021/0120255 A1
(43) Pub. Date: Apr. 22, 2021

(54) IMAGE COMPRESSION USING AUTOENCODER INFORMATION

(71) Applicant: Intel Corporation, Santa Clara, CA (US)

(72) Inventors: Xiaoran Fang, Shanghai (CN); Zheng Gao, Shanghai (CN); Hujun Yin, Saratoga, CA (US); Rongzhen Yang, Shanghai (CN)

(21) Appl. No.: 17/133,192

(22) Filed: Dec. 23, 2020

Related U.S. Application Data
(60) Provisional application No. 62/959,367, filed on Jan. 10, 2020.

(51) Int. Cl. H04N 19/29; H04N 19/146; G06T 3/40

(52) U.S. Cl. CPC H04N 19/29; G06T 3/40; H04N 19/146

(57) ABSTRACT

Methods, apparatus, systems, and articles of manufacture for image compression using autoencoder information are disclosed. An example apparatus disclosed herein includes a pre-compressor to compress an input scaled image to generate a fundamental bitstream and a reconstructed scaled image. The disclosed example apparatus also includes an autoencoder to encode a residual of a reconstructed image to generate a side information bitstream, the reconstructed image based on the reconstructed scaled image. The disclosed example apparatus further includes a bitstream merger to combine the fundamental bitstream and the side information bitstream to generate an output compressed bitstream.

### RELATED APPLICATION

This patent claims the benefit of U.S. Provisional Patent Application Ser. No. 62/959,367, which was filed on Jan. 10, 2020. U.S. Provisional Patent Application Ser. No. 62/959,367 is hereby incorporated herein by reference in its entirety. Priority to U.S. Provisional Patent Application Ser. No. 62/959,367 is hereby claimed.

### FIELD OF THE DISCLOSURE

This disclosure relates generally to image compression, and, more particularly, to image compression using autoencoder information.

### BACKGROUND

Image compression can be applied to images in order to reduce image size. For example, using image compression, images and videos can be stored and transmitted at lower sizes and bitrates.

### BRIEF DESCRIPTION OF THE DRAWINGS

FIG. 1 illustrates a block diagram of an example compression system implemented in accordance with teachings of this disclosure.

FIG. 2 illustrates a block diagram of an example system for compressing images using autoencoder information.

FIG. 3 illustrates a block diagram of an example hyperprior based autoencoder.

FIGS. 4-8 are example graphs illustrating evaluation results of the example compression system of FIG. 1.

FIG. 9 is a flowchart representative of machine readable instructions which may be executed to implement an example image compressor of FIG. 1.

FIG. 10 is a flowchart representative of machine readable instructions which may be executed to implement an example image decompressor of FIG. 1.

FIG. 11 is a block diagram of an example processing platform structured to execute the instructions of FIGS. 9-10 to implement the example image compressor and/or the example image decompressor of FIG. 1.

FIG. 12 illustrates a block diagram of example computer readable media that store code for compressing and decompressing images.

FIG. 13 is a block diagram of an example software distribution platform to distribute software (e.g., software corresponding to the example computer readable instructions of FIGS. 9-10) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time +/−1 second.

### DETAILED DESCRIPTION

Traditional coding methods prioritize video or image quality under certain bit-rate constraints for human consumption. For example, image compression methods, such as Joint Photographic Experts Group (JPEG), JPEG2000 and HEVC Intra Profile based Better Portable Graphic (BPG), as well as recent deep neural network (DNN) based image compression technologies have presented significant advances in image compression efficiency. In some examples, the DNN-based techniques exhibit a relatively better visual quality with respect to traditional methodologies at the same bit rate. For example, machines communicate amongst themselves to perform machine learning tasks using compressed images without a human in the mix. However, with the rise of machine learning applications (e.g., connected vehicles, video surveillance, smart cities, etc.), many intelligent platforms have been implemented with massive data requirements. Furthermore, traditional methods of image compression rely on hand-crafted modules, such as a discrete cosine transform used in JPEG on blocks of pixels, and a multi-scale orthogonal wavelet decomposition used in JPEG 2000. In DNN based techniques, DNNs use a loss function to evaluate the trained model (e.g., the trained compression method). In some examples, DNN based methods use Mean-Square Error (MSE) or SSIM as the loss function.

In some examples, machine learning tasks are performed on video or images after video or image compression. In traditional compression methods, an indicator of the compression method is the quality of reconstruction of the image and/or video frame from a visual perspective (e.g., for human viewing). For example, Peak Signal-to-Noise Ratio (PSNR) and Structural Similarity (SSIM) can be used to measure the visual quality of an image. However, many machine learning tasks are not directed to human viewing and, thus, do not consider the visual quality of the reconstructed image and/or video frame. For example, previous image compression solutions are not concerned about what kind of machine learning tasks are targeted to use the compressed images. Although previous compression techniques may be well designed, the overall compression system may not be end-to-end optimized. That is, previous solutions do not tailor image compression based on the target machine learning task. For example, previous solutions may be optimized for human viewing (e.g., the reconstructed image has a high PSNR, SSIM, etc.). However, the target machine learning task (e.g., object detection, etc.) may not need a reconstructed image with a high PSNR.

Examples disclosed herein relate generally to techniques for compressing images. For example, the disclosed example techniques can be used to compress still images and/or frames of video. Examples disclosed herein include an apparatus, method and system for compressing images using autoencoder information. Examples disclosed herein include compressing a scaled raw image to generate a fundamental bitstream and a reconstructed scaled image. For example, the scaled raw image is generated using a scale factor. Examples disclosed herein also include encoding a residual of the raw image and the reconstructed scaled image using autoencoders to generate side information. In examples disclosed herein, the autoencoders correspond to target machine learning tasks. Examples disclosed herein further include combining the fundamental bitstream and the side information bitstream to generate an output compressed bitstream.

Examples disclosed herein thus enable improved image compression with higher image quality for machine learning uses. In addition, examples disclosed herein can take particular goals of various machine learning tasks (e.g., target machine learning tasks) into account when performing image compression. Therefore, any use cases in which video and/or image features are to be compressed for machine learning tasks may benefit from such a compression method that generate images to be used in target machine learning tasks. Examples disclosed herein thus further improve image compression performance by jointly optimizing the compression system for human viewing and machine learning applications. That is, follow-up machine learning tasks (e.g., machine learning tasks after compression) are considered during the compression process. Moreover, because the image compression system disclosed herein is end-to-end optimized, this may result in better performance in various machine learning tasks, such as super resolution, object detection, etc. Examples disclosed herein use downscaling and upscaling operations to reduce signaling overhead.

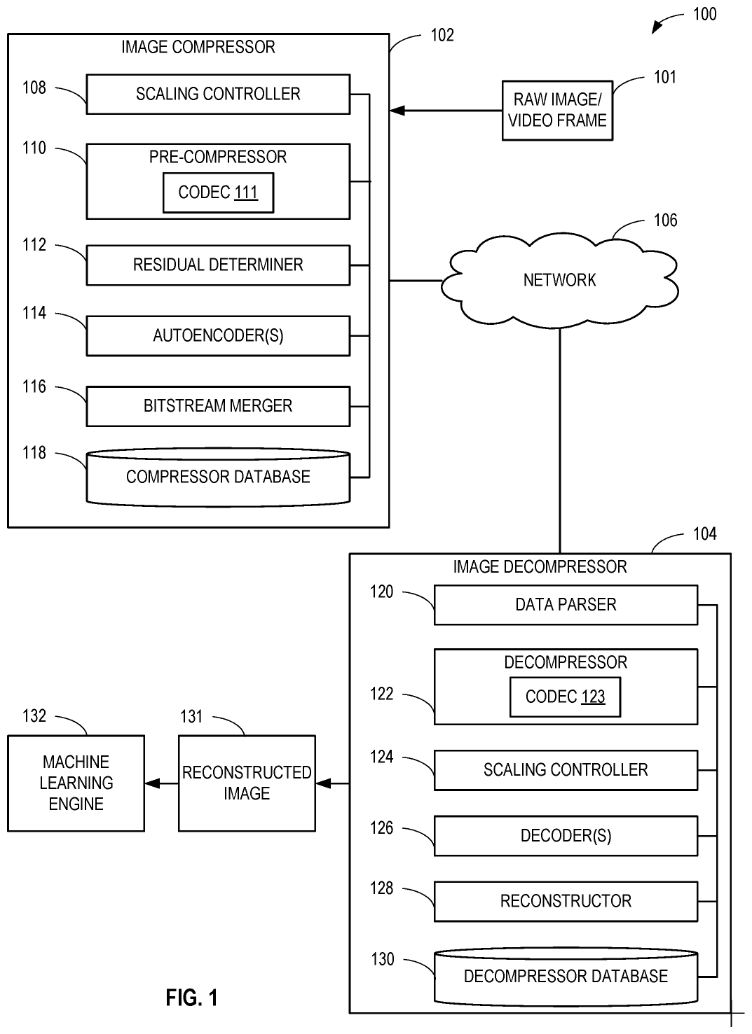

FIG. 1 illustrates a block diagram of an example compression system 100 implemented in accordance with teachings of this disclosure. The example compression system 100 includes an example image compressor 102, an example image decompressor 104, an example network 106, and an example machine learning engine 132.

The example image compressor 102 compresses images using autoencoder information. For example, the image compressor 102 receives an example raw image and/or raw video frame 101. For example, the raw image and/or raw video frame 101 can be captured by an image sensor (not illustrated). The example image compressor 102 downscales the raw image and inputs the scaled image into a codec (e.g., BPG, JPEG, etc.) to generate a fundamental bitstream and a reconstructed scaled image. The example image compressor 102 upscales the reconstructed scaled image and determines a residual value based on the difference between the raw image and the reconstructed scaled image.

The example image compressor 102 inputs the residual value into autoencoders corresponding to target machine learning tasks to generate side information. As used herein, side information refers to portions of the image and/or video frame corresponding to the target machine learning task. For example, if the target machine learning task is object detection, the side information can include portions of the image that include detected objects. In some examples, the image compressor 102 combines the side information bitstream generated by the autoencoders with the fundamental bitstream to support machine learning tasks. The example image compressor 102 includes an example scaling controller 108, an example pre-compressor 110, an example residual determiner 112, example autoencoder(s) 114, an example bitstream merger 116, and an example compressor database 118.

The example scaling controller 108 scales an image, x. In some examples, the scaling controller 108 implements means for scaling an image. In examples disclosed herein, the scaling controller 108 uses bicubic interpolation as the resampling filter for downscaling and/or upscaling an image. However, the scaling controller 108 can additionally or alternatively use any other resampling filter suitable for downscaling and/or upscaling an image. The example scaling controller 108 downscales the raw image using a scale factor, N. That is, if the raw image is x, the example scaling controller 108 generates a scaled image, x_{N}. In some examples, the scale factor is 2, 4, etc. For example, if the size of the raw image is (w, h) (e.g., a width w and a height h), the size of the scaled image is (w/N, h/N) (e.g., a width w/N and a height h/N). Additionally or alternatively, the example scaling controller 108 upscales an image. For example, the scaling controller 108 upscales a reconstructed scaled image, [symbol] command (described below), to generate a reconstructed image, \hat{x}. In examples disclosed herein, the reconstructed image is a size consistent with the raw image. That is, the reconstructed image has a size (w, h).

The example pre-compressor 110 compresses the scaled image, x_{N}, to generate a fundamental bitstream, y, and a reconstructed scaled image, [symbol] . In some examples, the pre-compressor 110 implements means for compressing an image. In examples disclosed herein, the fundamental bitstream is a binary file. The example pre-compressor 110 implements an example codec 111. For example, the codec 111 can be a HEVC Intra Profile based BPG codec, a JPEG codec, etc. Additionally or alternatively, the example pre-compressor 110 implements any other suitable image compression method for maintaining low-frequency components of the scaled image. In some examples, the pre-compressor 110 flags the fundamental bitstream for identification and/or sets a bit value identifying the fundamental bitstream. Additionally or alternatively, the pre-compressor 110 compresses the fundamental bitstream such that the fundamental bitstream is a compressed file format (e.g., a ZIP file, etc.).

The example residual determiner 112 determines a residual value, Δx, between the raw image, x, and the reconstructed image, \hat{x}. In some examples, the residual determiner 112 implements means for determining a residual. For example, the residual determiner 112 determines the residual value based on a difference between the raw image and the reconstructed image. That is, the residual value is Δx=x−\hat{x}.

The example autoencoder(s) 114 encode the residual value, Δx, of the raw image, x, and the reconstructed image, \hat{x}, to generate a side information bitstream, z. In some examples, the autoencoder(s) 114 implement means for encoding a bitstream. The example autoencoder(s) 114 are a type of artificial neural network used to learn efficient data coding in an unsupervised manner. For example, the autoencoder(s) 114 learn a representation (e.g., an encoding) for a set of data by training the network to ignore signal “noise.” For example, the autoencoder(s) 114 can perform dimensionality reduction. The autoencoder(s) 114 can solve applied problems, such as recognizing objects in images, acquiring the semantic meaning of images, etc. Due to different purposes, several variants of the autoencoder(s) 114 exist, such as a hyperprior based autoencoder, etc.

In examples disclosed herein, the autoencoder(s) 114 correspond to target machine learning tasks. For example, a first autoencoder corresponds to object detection, a second autoencoder corresponds to super resolution, a third autoencoder corresponds to anomaly detection, a fourth autoencoder corresponds to event search, etc. In some examples, the image compressor 102 encodes the residual value using the set of autoencoder(s) 114. Additionally or alternatively, the image compressor 102 encodes the residual value using the autoencoder corresponding to the target machine learning task. For example, if the raw image was captured by a smart car for object detection, the image compressor 102 uses an object detection based autoencoder to generate the side information bitstream. In some examples, the autoencoder(s) 114 flag the side information bitstreams for identification. Additionally or alternatively, the autoencoder(s) 114 generate side information bitstreams in a data format different from the fundamental bitstream.

The example bitstream merger 116 combines the fundamental bitstream, y, and the side information bitstream, z, to generate an output compressed bitstream, b. That is, the output compressed bitstream is b=y+z. In some examples, the bitstream merger 116 implements means for combining bitstreams. In some examples, the bitstream merger 116 stores the output compressed bitstream in the compressor database 118. In some examples, the output compressed bitstream is used for Bits Per Pixel (BPP) analysis. For example, the bitstream merger 116 determines the BPP of the output compressed bitstream in a manner consistent with example Equation 1.

$$B P P = \frac{bit length}{width * height} \qquad Equation 1$$

That is, the bitstream merger 116 determines the BPP by dividing the length of the bitstream (e.g., the output compressed bitstream) by the size of the image (e.g., the width and height). In some examples, the BPP is used as part of the loss function when training the autoencoder(s) 114 to achieve a better compression performance.

The example compressor database 118 stores the compressed bitstream. For example, the compressor database 118 stores the output compressed bitstream generated by the bitstream merger 116. The example compressor database 118 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example compressor database 118 may be in any data format such as, for example, binary data, comma delimited data, tab delimited data, structured query language (SQL) structures, etc. While, in the illustrated example, the compressor database 118 is illustrated as a single device, the example compressor database 118 and/or any other data storage devices described herein may be implemented by any number and/or type(s) of memories.

The example network 106 transmits the output compressed bitstream, b, from the example image compressor 102 to the example image decompressor 104. In some examples, the network 106 can be the Internet or any other suitable external network. Additionally or alternatively, any other suitable means of transmitting the output compressed bitstream from the example image compressor 102 to the example image decompressor 104 can be used.

The example image decompressor 104 decompresses the output compressed bitstream, b, to generate a reconstructed image, \tilde{x}. For example, the image decompressor 104 obtains the output compressed bitstream from the image compressor 102 via the network 106. The example image decompressor 104 separates the output compressed bitstream into a fundamental bitstream and a side information bitstream. The example image decompressor 104 decompresses the fundamental bitstream to generate a base image and decodes the side information bitstream to generate auxiliary information. The example decompressor combines the base image and the auxiliary information to generate a reconstructed image that can be used for a target machine learning task. The example image decompressor 104 includes an example data parser 120, an example decompressor 122, an example scaling controller 124, an example decoder(s) 126, an example reconstructor 128, and an example decompressor database 130.

The example data parser 120 parses the output compressed bitstream, b. In some examples, the data parser 120 implements means for separating bitstreams. For example, the data parser 120 separates the output compressed bitstream into two bitstreams: the fundamental bitstream, y, and the side information bitstream, z. In some examples, the data parser 120 separates the output compressed bitstream based on a flag, a bit value, a data format, etc. For example, the data parser 120 identifies the fundamental bitstream based on a flag set by the example pre-compressor 110 and/or identifies the side information bitstream based on a flag set by the autoencoder(s) 114. Additionally or alternatively, the data parser 120 identifies the fundamental bitstream and/or the side information bitstream based on a data format. For example, the fundamental bitstream may be a compressed file format (e.g., a ZIP file).

The example decompressor 122 decompresses the fundamental bitstream, y, to generate the scaled image, [symbol] . In some examples, the decompressor 122 implements means for decompressing an image. For example, the decompressor 122 implements an example codec 123. For example, the codec 123 can be a HEVC Intra Profile based BPG codec, a JPEG codec, etc. to generate the scaled image. In examples disclosed herein, the decompressor 122 implements the same type of codec (e.g., the codec 111) implemented by the example pre-compressor 110.

The example scaling controller 124 scales the scaled image, [symbol] , to generate the base image, \hat{x}. In some examples, the scaling controller 124 implements means for scaling an image. For example, the scaling controller 124 upscales the scaled image by the scale factor, N, such that the base image is the same size as the raw image, x. That is, the base image has a size of (w, h).

The example decoder(s) 126 decode the side information bitstream, z, to generate an auxiliary bitstream, [symbol] . In some examples, the decoder(s) 126 implement means for decoding a bitstream. For example, the decoder(s) 126 perform the autoencoder decoding process. That is, the decoder(s) 126 correspond to the autoencoder(s) 114. In examples disclosed herein, the auxiliary bitstream includes the components of the image (e.g., the reconstructed image) that are useful for the target machine learning tasks (e.g., super resolution, object recognition, etc.).

The example reconstructor 128 combines the base image, \hat{x}, and the auxiliary bitstream, [symbol] , to generate a reconstructed image, \tilde{x}. That is, the reconstructed image is \tilde{x}=\tilde{x}+ [symbol] . In some examples, the reconstructor 128 implements means for generating an image. For example, the reconstructor 128 generates an example reconstructed image 131. Thus, the reconstructed image includes data (e.g., the auxiliary bitstream) for specific machine learning tasks. In some examples, the reconstructor 128 stores the reconstructed image 131 in the decompressor database 130.

The example decompressor database 130 stores reconstructed images. For example, the decompressor database 130 stores the reconstructed image 131 (e.g., \tilde{x}) generated by the reconstructor 128. The example decompressor database 130 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example decompressor database 130 may be in any data format such as, for example, binary data, comma delimited data, tab delimited data, structured query language (SQL) structures, etc.

The example machine learning engine 132 generates models based on the example reconstructed image, \tilde{x}. For example, the machine learning engine 132 accesses the reconstructed image 131. For example, the machine learning engine 132 can be trained for a specific machine learning task (e.g., super resolution, object recognition, etc.). The example machine learning engine 132 generates a model using the auxilary bitstream stored in the reconstructed image 131 to perform the machine learning task on the base image.

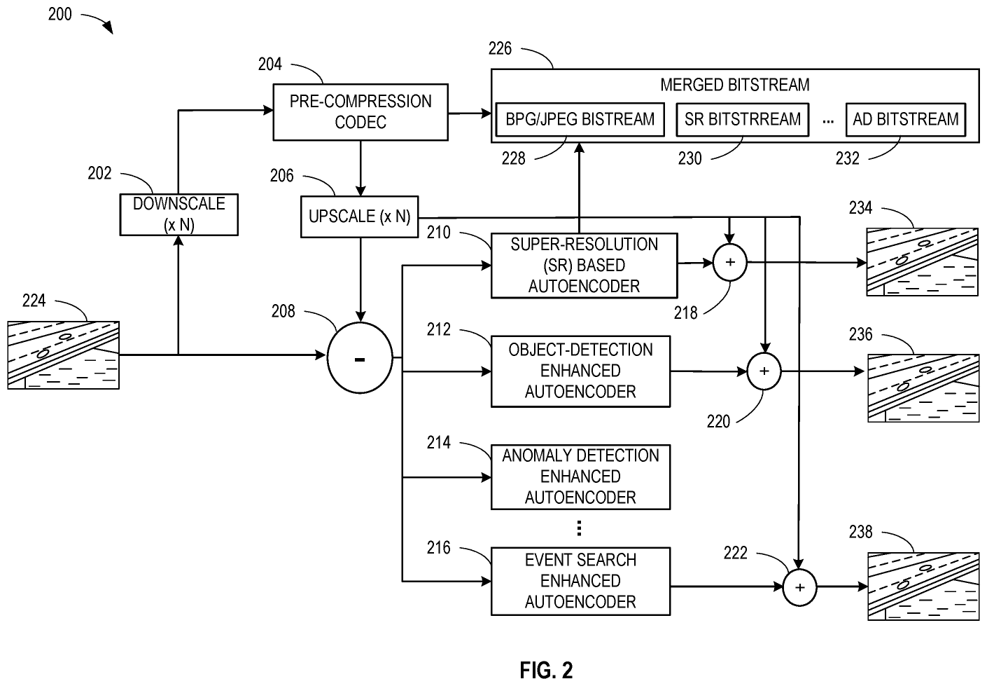

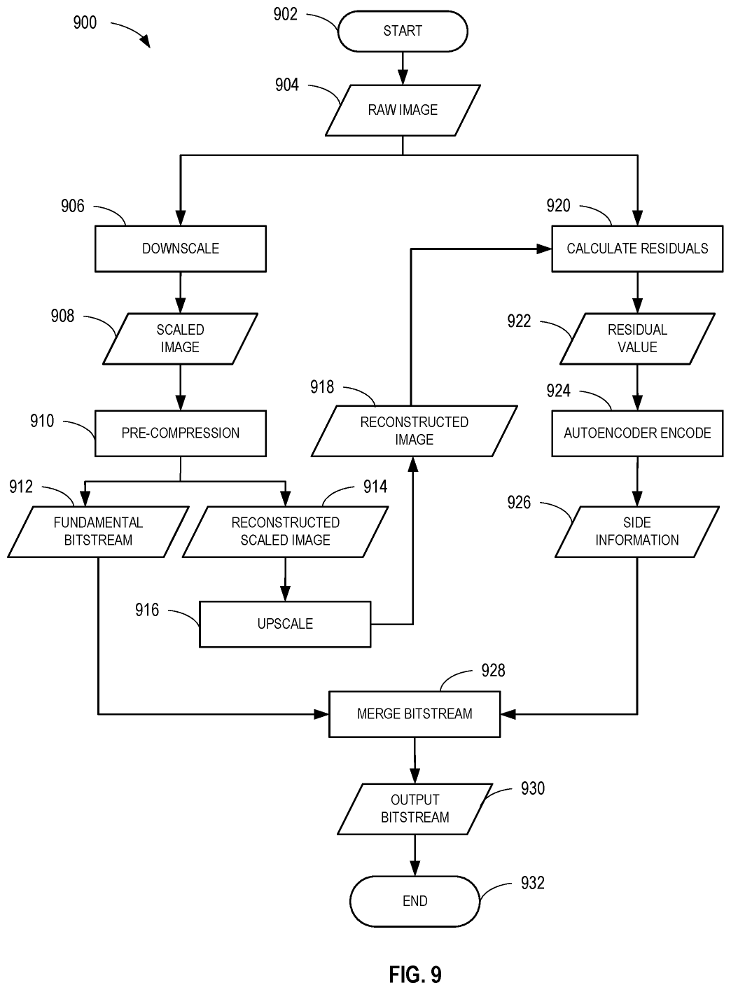

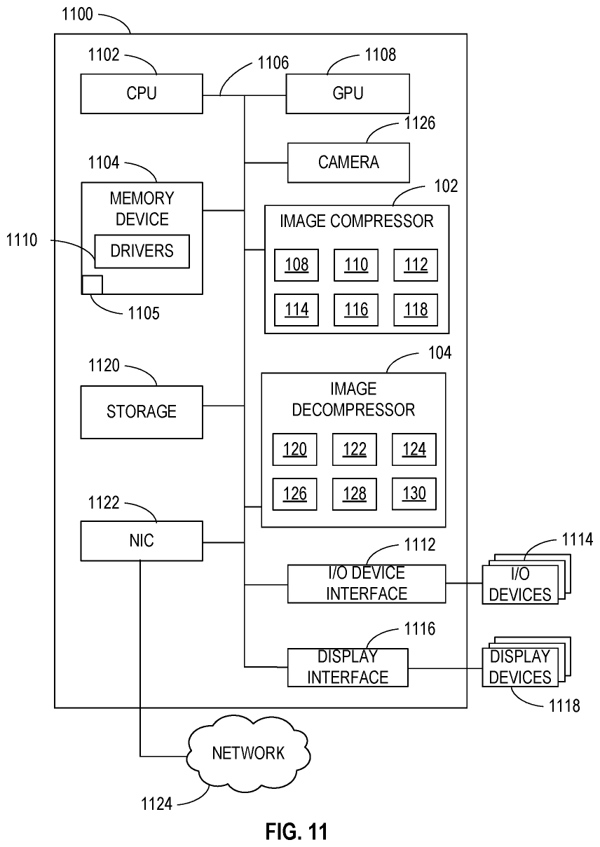

FIG. 2 illustrates a block diagram of an example system 200 for compressing images using autoencoder information. In the illustrated example of FIG. 2, the system 200 includes three parts: an example pre-compression codec 204, a set of autoencoders including an example Super Resolution (SR) based autoencode 210, an example object-detection enhanced autoencoder 212, an example anomaly detection enhanced autoencoder 214, and an example event search enhanced autoencoder 216, and an example generated bitstream 226 for BPP analysis. The example system 200 can be implemented in the computing device 1100 in FIG. 11 using the instructions 900 of FIG. 9.

The example system 200 includes an example downscaler 202. In some examples, the downscaler 202 implements the scaling controller 108 of FIG. 1. The downscaler 202 accesses an example raw image 224 (e.g., x) and downscales the raw image 224 by the scale factor (e.g., N). That is, the example downscaler 202 generates a scaled image. The system 200 also includes the example pre-compression codec 204 communicatively coupled to the downscaler 202. In some examples, the pre-compression codec 204 implements the pre-compressor 110of FIG. 1. The pre-compression codec 204 accesses the scaled image and compresses the scaled image using an image codec. For example, the image codec may be any suitable image codec (e.g., BPG, JPEG, etc.). The example pre-compression codec 204 generates an example fundamental bitstream 228 and a reconstructed scaled image (e.g., [symbol] ).

The system 200 also includes an example upscaler 206 communicatively coupled to the pre-compression codec 204. In some examples, the upscaler 206 implements the example scaling controller 108. The example upscaler 206 accesses the reconstructed scaled image generated by the example pre-compression codec 204 and upscales the reconstructed scaled image by the scale factor. That is, the upscaler 206 generates a reconstructed image the same size as the raw image 224. The system 200 includes an example residual calculator 208 communicatively coupled to the upscaler 206. In some examples, the residual calculator 208 implements the example residual determiner 112 of FIG. 1. The example residual calculator 208 determines a residual value based on the difference between the raw image 224 and the reconstructed image generated by the example upscaler 206.

The system 200 includes the example SR based autoencoder 210, the example object-detection enhanced autoencoder 212, the example anomaly detection enhanced autoencoder 214 (e.g., used for video streams), and the example event search enhanced autoencoder 216 (e.g., used for video streams) communicatively coupled to the residual calculator 208. The system 200 can use various kinds of autoencoders as indicated by ellipses. In some examples, the autoencoders 210, 212, 214, 216 implement the example autoencoder(s) 114 of FIG. 1. The autoencoders 210, 212, 214, 216 access the residual value between the raw image 224 and the reconstructed image generated by the residual calculator 208. The example autoencoders 210, 212, 214, 216 are designed and trained for specific machine learning tasks. That is, the example autoencoders 210, 212, 214, 216 generate side information corresponding to target machine learning tasks. For example, the SR based autoencoder 210 generates side information corresponding to SR information, the object-detection enhanced autoencoder 212 generates side information corresponding to object detection information, etc.

The system 200 includes an example first combiner 218 communicatively coupled to the SR based autoencoder 210, an example second combiner 220 communicatively coupled to the object-detection enhanced autoencoder 212, and an example third combiner 222 communicatively coupled to the event search enhanced autoencoder 216. The example combiners 218, 220, 222 combine the side information generated by the example autoencoders 210, 212, 214, 216 with the reconstructed image. For example, the combiner 218 generates an example SR image 234, the combiner 220 generates an example object-detection image 236, and the combiner 222 generates an example event search image 238. In some examples, the autoencoders 210, 212, 214, 216 are associated with a combiner. For example, a fourth combiner (not illustrated) may combine the side information generated by the example anomaly detection enhanced autoencoder with the reconstructed image.

The example autoencoders 210, 212, 214, 216 generate side information. For example, the SR based autoencoder 210 generates an example SR bitstream 230 (e.g., including the example SR image 234) and the anomaly detection enhanced autoencoder 214 generates an example AD bitstream 232. The example bitstream merger 116 of FIG. 1 optionally combines the fundamental bitstream 228 with the side information bitstreams 230, 232 to support the target machine learning tasks.

Although the illustrated example of FIG. 2 includes an image based shared backbone design, in various examples the system 200 can be extended to video based shared backbone with the same structure. For example, the pre-compression codec 204 may be replaced with a video codec, and the image based autoencoders 210, 212, 214, 216 may be replaced with video based autoencoders. For example, the conventional video codec can be the High Efficiency Video Coding (HEVC) codec, Versatile Video Coding (VVC), etc.

The diagram of FIG. 2 is not intended to indicate that the example system 200 is to include all of the components illustrated in FIG. 2. Rather, the example system 200 can be implemented using fewer or additional components not illustrated in FIG. 2 (e.g., additional images, autoencoders, bitstreams, codecs, downscalers, upscalers, etc.).

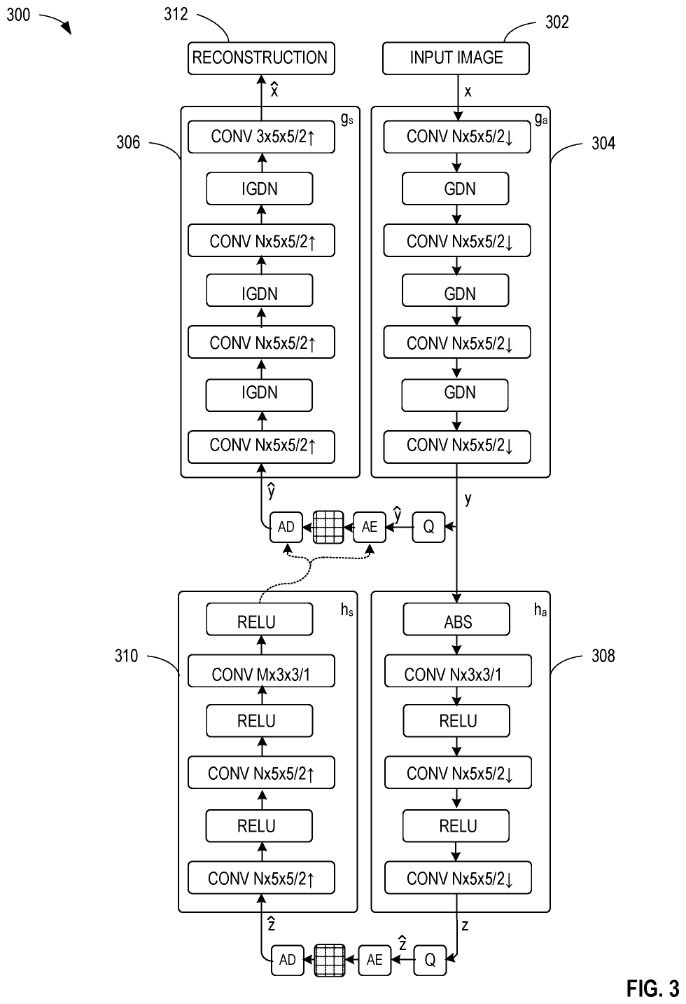

FIG. 3 illustrates a block diagram of an example hyperprior based autoencoder 300. For example, the hyperprior based autoencoder 300 can generate side information for machine learning tasks such as image enhancement and SR. In some examples, the hyperprior based autoencoder 300 implements the SR based autoencoder 210 of FIG. 2. The hyperprior based autoencoder 300 accesses an example input image 302 For example, the input image 302 is a residual value of a raw image and an upscaled reconstructed image. The hyperprior based autoencoder 300 includes an example first block 304, an example second block 306, an example third block 308, and an example fourth block 310. The example blocks 304, 306 of the hyperprior based autoencoder 300 are an image autoencoder architecture. The example blocks 308, 310 of the hyperprior based autoencoder 300 are autoencoders implementing a hyperprior. The example hyperprior based autoencoder 300 generates an example reconstruction 312. For example, the reconstruction 312 is the side information corresponding to SR.

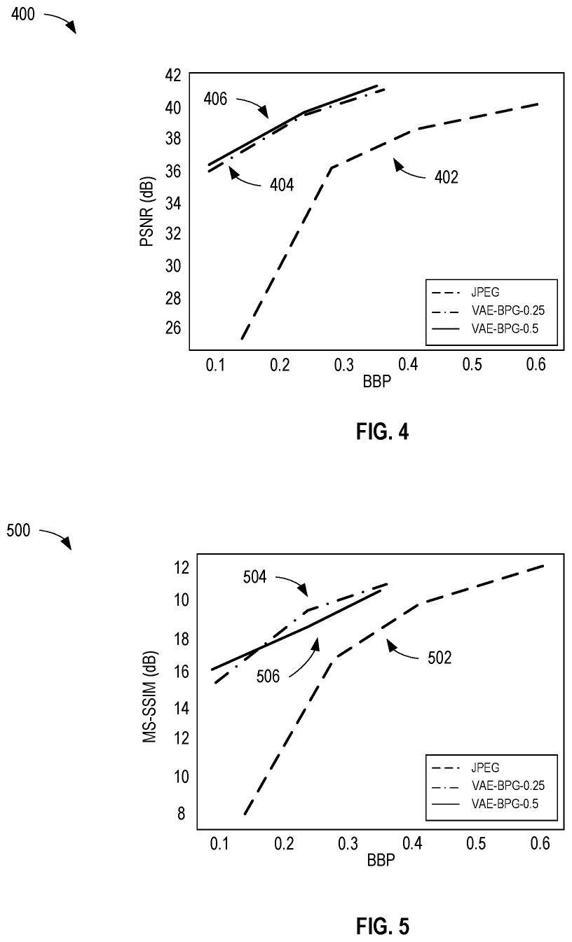

FIGS. 4-8 are example graphs illustrating evaluation results of the example compression system 100 of FIG. 1. In the illustrated examples of FIGS. 4-8, the evaluation was performed on the Cityscapes dataset. For the evaluation, the target machine learning task was SR. That is, the example SR based autoencoder 210 of FIG. 2 generated side information for SR. In examples disclosed herein, the SR based autoencoder 210 implements the example hyperprior based autoencoder 300 of FIG. 3 using MSE and BPP as the loss function. In the illustrated examples of FIGS. 4-8, the scaling controllers 108, 124 of FIG. 1 and/or the downscaler 202 and the upscaler 206 of FIG. 2 scale the Cityscapes dataset using a first scale factor of 2 (e.g., N=2) and a second scale factor of 4 (e.g., N=4). In some examples, the resampling filter is bicubic interpolation. In the illustrated examples of FIGS. 4-8, the pre-compressor 110 of FIG. 1 implements the BPG codec.

FIG. 4 is an example graph 400 illustrating an example PSNR evaluation result of the example compression system 100 of FIG. 1. In some examples, PSNR is used as an indicator of SR performance. In the illustrated example of FIG. 4, the x-axis is BPP. That is, the x-axis represents the BPP of the compressed images of the Cityscapes dataset. The y-axis of the example graph 400 represents PSNR. That is, the y-axis represents the PSNR of the compressed images of the Cityscapes dataset. The example graph 400 includes example JPEG data 402, example first compressed data 404, and example second compressed data 406. In the illustrated example of FIG. 4, the JPEG data 402 corresponds to the Cityscapes dataset compressed using the JPEG compression method. As described above, the example compression system 100 generates the example first compressed data 404 using a scale factor of 4 and generates the example second compressed data 406 using a scale factor of 2. In the illustrated example of FIG. 4, the compressed data 404, 406 have relatively higher PSNR values with respect to the JPEG data 402 for the same BPP values. Thus, examples disclosed herein generate better quality SR images compared to the conventional JPEG compression method when evaluating PSNR.

FIG. 5 is an example graph 500 illustrating an example Multi-Scale SSIM (MS-SSM) evaluation result of the example compression system 100 of FIG. 1. In some examples, MS-SSM is used as an indicator of SR performance. In the illustrated example of FIG. 5, the x-axis is BPP. The y-axis of the example graph 500 represents MS-SSM. That is, the y-axis represents the MS-SSM of the compressed images of the Cityscapes dataset. The example graph 500 includes example JPEG data 502, example first compressed data 504, and example second compressed data 506. In the illustrated example of FIG. 5, the JPEG data 502 corresponds to the Cityscapes dataset compressed using the JPEG compression method. The example first compressed data 504 corresponds to the Cityscapes dataset compressed using techniques disclosed herein with a scale factor of 4. Similarly, the example second compressed data 506 corresponds to the Cityscapes dataset compressed using techniques disclosed herein with a scale factor of 2. In the illustrated example of FIG. 5, the compressed data 504, 506 have relatively higher MS-SSM values with respect to the JPEG data 502 for the same BPP values. Thus, examples disclosed herein generate better quality SR images compared to the conventional JPEG compression method when evaluating MS-SSM.

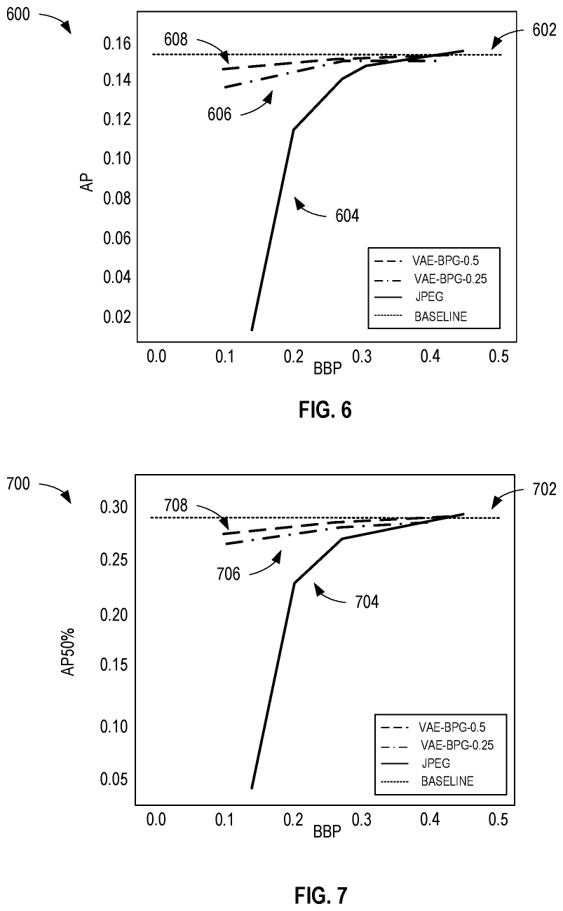

FIG. 6 is an example graph 600 illustrating an example Average Precision (AP) evaluation result of the example compression system 100 of FIG. 1. In the illustrated example of FIG. 6, the target machine learning task is instance segmentation. The example evaluation result was generated using Mask Region Based Convolutional Neural Network (R-CNN). In some examples, AP is used as an indicator of instance segmentation performance. For example, AP measures recall and precision of the instance segmentation performance. In the illustrated example of FIG. 6, the x-axis is BPP. The y-axis of the example graph 600 represents the AP of the compressed Cityscapes dataset. That is, the y-axis represents the AP value (e.g., the percentage of correct object identifications) of the Cityscapes dataset.

The example graph 600 includes an example baseline 602, example JPEG data 604, example first compressed data 606, and example second compressed data 608. The example baseline data 602 corresponds to the AP values of the instance segmentation of uncompressed Cityscapes dataset. In the illustrated example of FIG. 6, the baseline 602 is the upper bound. The example JPEG data 604 corresponds to the Cityscapes dataset compressed using the JPEG compression method. The example first compressed data 606 corresponds to the Cityscapes dataset compressed using techniques disclosed herein with a scale factor of 4. Similarly, the example second compressed data 608 corresponds to the Cityscapes dataset compressed using techniques disclosed herein with a scale factor of 2. In the illustrated example of FIG. 6, the compressed data 606, 608 have relatively higher AP values with respect to the JPEG data 604 for a low BPP range (e.g., BPP<0.3). In a high BPP range (e.g., BPP>0.3), the AP values of the JPEG data 604 and the compressed data 606, 608 approach the upper bound (e.g., the baseline 602). Thus, examples disclosed herein have a better instance segmentation performance compared to the conventional JPEG compression method when evaluating AP.

FIG. 7 is an example graph 700 illustrating an example Average Precision 50% (AP50%) evaluation result of the example compression system 100 of FIG. 1. In the illustrated example of FIG. 7, the target machine learning task is instance segmentation. In some examples, AP50% is used as an indicator of instance segmentation performance. In the illustrated example of FIG. 7, the x-axis is BPP. The y-axis of the example graph 700 represents the AP50% of the compressed Cityscapes dataset. That is, the y-axis represents the AP value with the Intersection over Union (IoU) threshold at 50%.

The example graph 700 includes an example baseline 702, example JPEG data 704, example first compressed data 706, and example second compressed data 708. The example baseline data 702 corresponds to the AP50% values of uncompressed Cityscapes dataset. The example JPEG data 704 corresponds to the Cityscapes dataset compressed using the JPEG compression method. The example first compressed data 706 corresponds to the Cityscapes dataset compressed using techniques disclosed herein with a scale factor of 4. Similarly, the example second compressed data 708 corresponds to the Cityscapes dataset compressed using techniques disclosed herein with a scale factor of 2. In the illustrated example of FIG. 7 the compressed data 706, 708 have relatively higher AP50% values with respect to the JPEG data 704 for a low BPP range (e.g., BPP<0.3). In a high BPP range (e.g., BPP>0.3), the AP50% values of the JPEG data 704 and the compressed data 706, 708 approach the upper bound (e.g., the baseline 702). Thus, examples disclosed herein have a better instance segmentation performance compared to the conventional JPEG compression method when evaluating AP50%.

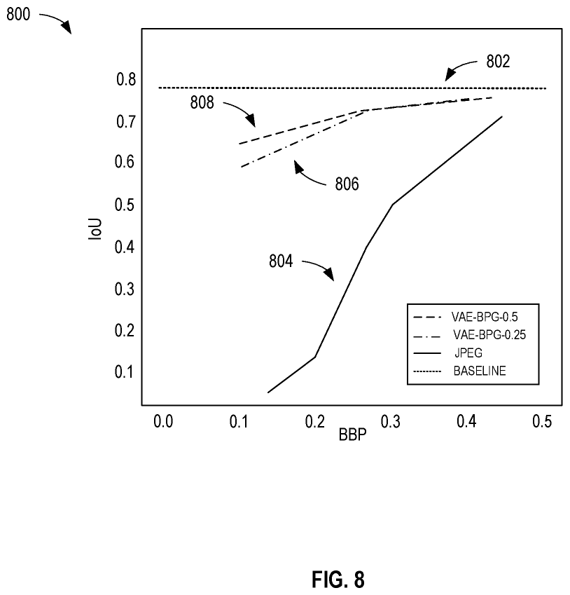

FIG. 8 is an example graph 800 illustrating an example IoU evaluation result of the example compression system 100 of FIG. 1. In the illustrated example of FIG. 8, the target machine learning task is semantic segmentation. In the illustrated example of FIG. 8, the DeepLab model was used for semantic segmentation of the Cityscapes dataset. In some examples, IoU is used as an indicator of semantic segmentation performance. In the illustrated example of FIG. 8, the x-axis is BPP. The y-axis of the example graph 800 represents the IoU of the semantic segmentation performance of the compressed Cityscapes dataset. That is, the y-axis represents the IoU value (e.g., the area of overlap divided by the area of union between the ground truth bounding box and the predicted bounding box of an object) of the Cityscapes dataset.

The example graph 800 includes an example baseline 802, example JPEG data 804, example first compressed data 806, and example second compressed data 808. The example baseline data 802 corresponds to the IoU values of the semantic segmentation of uncompressed Cityscapes dataset. In the illustrated example of FIG. 8, the baseline 802 is the upper bound. The example JPEG data 804 corresponds to the Cityscapes dataset compressed using the JPEG compression method. The example first compressed data 806 corresponds to the Cityscapes dataset compressed using techniques disclosed herein with a scale factor of 4. Similarly, the example second compressed data 808 corresponds to the Cityscapes dataset compressed using techniques disclosed herein with a scale factor of 2. In the illustrated example of FIG. 8, the compressed data 806, 808 have relatively higher IoU values with respect to the JPEG data 804. In a high BPP range (e.g., BPP>0.3), the IoU values of the JPEG data 804 and the compressed data 806, 808 approach the upper bound (e.g., the baseline 802). Thus, examples disclosed herein have a better semantic segmentation performance compared to the conventional JPEG compression method when evaluating IoU.

While an example manner of implementing the image compressor 102 and the image decompressor 104 of FIG. 1 is illustrated in FIG. 1, one or more of the elements, processes and/or devices illustrated in FIG. 1 may be combined, divided, re-arranged, omitted, eliminated and/or implemented in any other way. Further, the example scaling controller 108, the example pre-compressor 110, the example residual determiner 112, the example autoencoder(s) 114, the example bitstream merger 116, the example compressor database 118, the example data parser 120, the example decompressor 122, the example scaling controller 124, the example decoder(s) 126, the example reconstructor 128, the example decompressor database 130 and/or, more generally, the example image compressor 102 and the example decompressor 104 of FIG. 1 may be implemented by hardware, software, firmware and/or any combination of hardware, software and/or firmware. Thus, for example, any of the example scaling controller 108, the example pre-compressor 110, the example residual determiner 112, the example autoencoder(s) 114, the example bitstream merger 116, the example compressor database 118, the example data parser 120, the example decompressor 122, the example scaling controller 124, the example decoder(s) 126, the example reconstructor 128, the example decompressor database 130 and/or, more generally, the example image compressor 102 and the example image decompressor 104 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, scaling controller 108, the example pre-compressor 110, the example residual determiner 112, the example autoencoder(s) 114, the example bitstream merger 116, the example compressor database 118, the example data parser 120, the example decompressor 122, the example scaling controller 124, the example decoder(s) 126, the example reconstructor 128, the example decompressor database 130, and/or the image compressor 102 and the example image decompressor 104 is/are hereby expressly defined to include a non-transitory computer readable storage device or storage disk such as a memory, a digital versatile disk (DVD), a compact disk (CD), a Blu-ray disk, etc. including the software and/or firmware. Further still, the example image compressor 102 and the example image decompressor 104 of FIG. 1 may include one or more elements, processes and/or devices in addition to, or instead of, those illustrated in FIG. 1, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

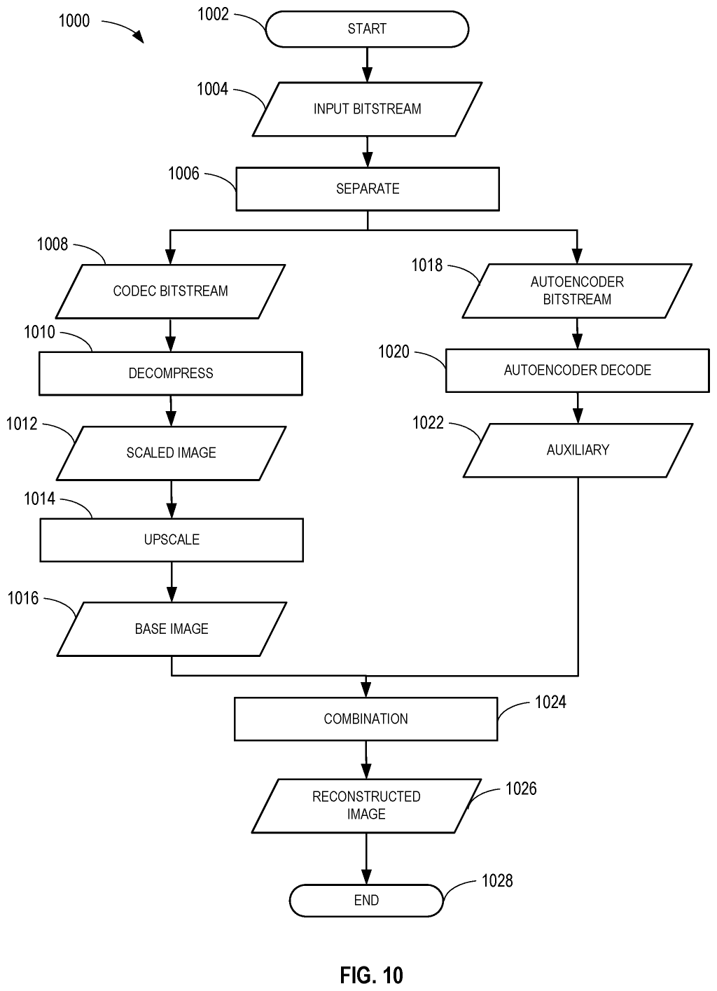

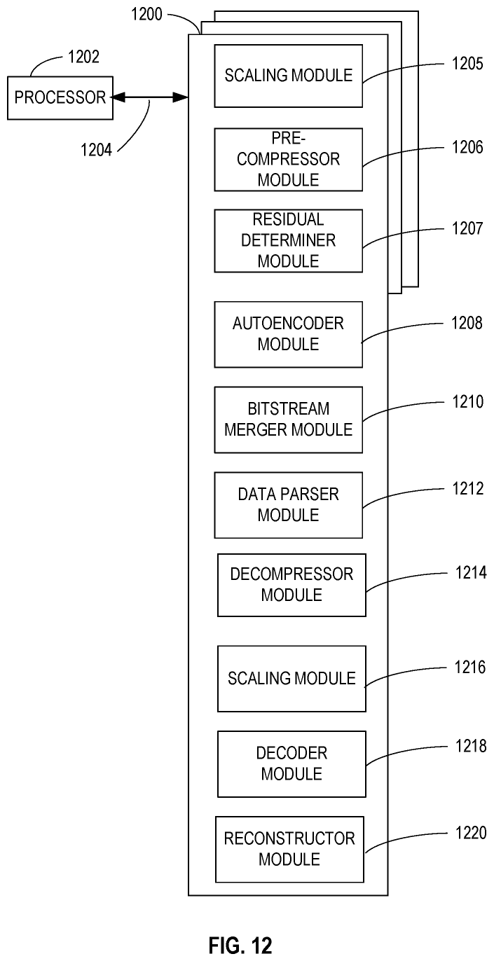

Flowchart representative of example hardware logic, machine readable instructions, hardware implemented state machines, and/or any combination thereof for implementing the example image compressor 102 and/or the example image decompressor 104 of FIG. 1 are shown in FIGS. 9-10. The machine readable instructions may be one or more executable programs or portion(s) of an executable program for execution by a computer processor and/or processor circuitry, such as the processor 1202 discussed below in connection with FIG. 12. The program may be embodied in software stored on a non-transitory computer readable storage medium such as a CD-ROM, a floppy disk, a hard drive, a DVD, a Blu-ray disk, or a memory associated with the processor 1202, but the entire program and/or parts thereof could alternatively be executed by a device other than the processor 1202 and/or embodied in firmware or dedicated hardware. Further, although the example program is described with reference to the flowcharts illustrated in FIGS. 9-10, many other methods of implementing the example image compressor 102 and/or the example image decompressor 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an field-programmable gate array (FPGA), an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 9-10 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a,” “an,” “first,” “second,” etc.) do not exclude a plurality. The term “a” or “an” entity, as used herein, refers to one or more of that entity. The terms “a” (or “an”), “one or more,” and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 9 is a flowchart representative of machine readable instructions 900 which may be executed to implement the example image compressor 102 of FIG. 1. In some examples, the machine readable instructions cause a processor to implement the example image compressor 102 of FIG. 1 to perform image compression. The instructions 900 of FIG. 9 include block 902, at which image compression starts. The example image compressor 102 (FIG. 1) accesses a raw image (block 904). For example, the image compressor 102 reads the raw image, x. The example scaling controller 108 (FIG. 1) downscales the raw image (block 906). For example, the scaling controller downscales the raw image by a scale factor, N, to generate a scaled image, x_{N} (block 908).

The example pre-compressor 110 (FIG. 1) compresses the scaled image (block 910). For example, the pre-compressor 110 compresses the scaled image using a conventional image codec (e.g., JPEG, BPG, etc.). The example pre-compressor 110 generates an example fundamental bitstream, y (block 912). For example, the fundamental bitstream is binary data. Additionally or alternatively, the example pre-compressor 110 generates an example reconstructed scaled image, [symbol] (block 914).

The example scaling controller 108 upscales the reconstructed scaled image (block 916). For example, the scaling controller 108 upscales the reconstructed scaled image by the scale factor, N, to generate a reconstructed image, \hat{x} (block 918). For example, the reconstructed image is the same size as the raw image (e.g., block 904). The example residual determiner 112 (FIG. 1) calculates residuals (block 920). For example, the residual determiner 112 calculates a difference between the raw image (e.g., block 904) and the reconstructed image (e.g., block 918) to determine the residual value, Δx (block 922).

The example autoencoder(s) 114 (FIG. 1) encode the residual value (block 924). For example, a set of autoencoders (e.g., the autoencoders 210, 212, 214, 216 of FIG. 2) encode the residual value for target machine learning tasks. For example, if the target machine learning task is super resolution, the example SR based autoencoder 210 encodes the residual value, etc. The autoencoder(s) 114 generate a side information bitstream, z (block 926). That is, the side information bitstream includes data for the target machine learning tasks.

The example bitstream merger 116 (FIG. 1) merges bitstreams (block 928). For example, the bitstream merger 116 combines the fundamental bitstream (e.g., block 912) and the side information bitstream (e.g., block 926). The bitstream merger 116 generates the output bitstream, b (block 930). In some examples, the bitstream merger 116 stores the output bitstream in the example compressor database 118 (FIG. 1). At block 932, the image compression ends.

FIG. 10 is a flowchart representative of machine readable instructions 1000 which may be executed to implement an example image decompressor 104 of FIG. 1. In some examples, the machine readable instructions cause a processor to implement the example image decompressor 104 of FIG. 1 to perform image decompression. The instructions 1000 of FIG. 10 include block 1002, at which image decompression starts. At block 1004, the example image decompressor 104 accesses the example input bitstream, b. For example, the image decompressor 104 reads the input bitstream generated by the example image compressor 102 (FIG. 1).

The example data parser 120 (FIG. 1) separates the input bitstream (block 1006). For example, the data parser 120 separates the input bitstream into the fundamental bitstream and the side information bitstream. In some examples, the data parser 120 separates the input bitstream based on a flag (e.g., a fundamental bitstream flag, a side information bitstream flat, etc.) and/or a data format (e.g., compressed data, etc.). The data parser 120 generates the codec bitstream (block 1008). For example, the codec bitstream is the fundamental bitstream, y.

The example decompressor 122 (FIG. 1) decompresses the fundamental bitstream (block 1010). For example, the decompressor 122 decompresses the fundamental bitstream using a conventional image codec. In examples disclosed herein, the decompressor 122 uses the same image codec as the example pre-compressor 110. The example decompressor 122 generates the scaled image, [symbol] (block 1012).

The example scaling controller 124 (FIG. 1) upscales the scaled image (block 1014). For example, the scaling controller 124 upscales the scaled image by the scale factor, N. The scaling controller 124 generates the base image, \hat{x} (block 1016). For example, the base image has the same size as the raw image accessed by the example image compressor 102.

Returning to block 1006, the example data parser 120 generates an autoencoder bitstream (block 1018). For example, the autoencoder bitstream is the side information bitstream, z. The example decoder(s) 126 (FIG. 1) decode the side information bitstream (block 1020). For example, the decoder(s) 126 decode the side information bitstream based on the target machine learning task. For example, if the target machine learning task is super resolution and the side information bitstream includes side information for super resolution (e.g., the SR bitstream 230 of FIG. 2), one of the decoder(s) 126 is an SR based decoder. The example decoder(s) 126 generate auxiliary information, [symbol] (block 1022). For example, the auxiliary information includes components of the image for the target machine learning task.

The example reconstructor 128 (FIG. 1) combines the base image and the auxiliary information (block 1024). For example, the reconstructor 128 combines the base image (e.g., block 1016) and the auxiliary information (e.g., block 1022) to generate the reconstructed image, \tilde{x} (block 1026). In some examples, the reconstructor 128 stores the reconstructed image in the example decompressor database 130 (FIG. 1). At block 1028, the image decompression ends. The reconstructed image can be used for the target machine learning task(s). For example, the machine learning engine 132 (FIG. 1) accesses the reconstructed image to perform object detection, super resolution, etc.

Referring now to FIG. 11, a block diagram is shown illustrating an example computing device that can compress and decompress images with autoencoder information. The computing device 1100 may be, for example, a server, a laptop computer, desktop computer, tablet computer, mobile device (e.g., a cell phone, a smart phone), an Internet appliance, a DVD player, a CD player, a digital video recorder, a Blu-ray player, a gaming console, a personal video recorder, a set top box, a headset or wearable device, among others. In some examples, the computing device 1100 may be a video camera, such as a security camera or other image recording device.

The computing device 1100 may include a central processing unit (CPU) 1102 that is configured to execute stored instructions, as well as a memory device 1104 that stores computer readable instructions 1105 that are executable by the CPU 1102 The CPU 1102 of the illustrated example is hardware. For example, the CPU 1102 can be implemented by one or more integrated circuits, logic circuits, microprocessors, DSPs, or controllers from any desired family or manufacturer. The hardware processor may be a semiconductor based (e.g., silicon based) device. The CPU 1102 may be coupled to the memory device 1104 by a bus 1106. Additionally, the CPU 1102 can be a single core processor, a multi-core processor, a computing cluster, or any number of other configurations. Furthermore, the computing device 1100 may include more than one CPU 1102. In some examples, the CPU 1102 may be a system-on-chip (SoC) with a multi-core processor architecture. In some examples, the CPU 1102 can be a specialized digital signal processor (DSP) used for image processing.

The memory device 1104 can include random access memory (RAM), read only memory (ROM), flash memory, or any other suitable memory systems. For example, the memory device 1104 may include dynamic random access memory (DRAM). The computing device 1100 of the illustrated example can include a volatile memory and a non-volatile memory. The volatile memory may be implemented by Synchronous Dynamic Random Access Memory (SDRAM), DRAM, RAMBUS® Dynamic Random Access Memory (RDRAM®) and/or any other type of random access memory device. The non-volatile memory may be implemented by flash memory and/or any other desired type of memory device. Access to the memory device 1104 is controlled by a memory controller.

The computing device 1100 may also include a graphics processing unit (GPU) 1108. As shown, the CPU 1102 may be coupled through the bus 1106 to the GPU 1108. The GPU 1108 may be configured to perform any number of graphics operations within the computing device 1100. For example, the GPU 1108 may be configured to render or manipulate graphics images, graphics frames, videos, or the like, to be displayed to a user of the computing device 1100.

The memory device 1104 may include device drivers 1110 that are configured to execute the instructions for training multiple convolutional neural networks to perform sequence independent processing. The device drivers 1110 may be software, an application program, application code, or the like.

The CPU 1102 may also be connected through the bus 1106 to an input/output (I/O) device interface 1112 configured to connect the computing device 1100 to one or more I/O devices 1114. The I/O device(s) 1114 permit(s) a user to enter data and/or commands into the computing device 1100. The I/O devices 1114 may include, for example, an audio sensor, a microphone, a camera (still or video), a keyboard and a pointing device, wherein the pointing device may include a touchpad or a touchscreen, a trackball, isopoint and/or a voice recognition system, among others. The I/O device(s) 1114 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The I/O device interface 1112 of the illustrated example, thus, typically includes a graphics driver card, a graphics driver chip and/or a graphics driver processor. The I/O devices 1114 may be built-in components of the computing device 1100, or may be devices that are externally connected to the computing device 1100. In some examples, the memory 1104 may be communicatively coupled to I/O devices 1114 through direct memory access (DMA).

The CPU 1102 may also be linked through the bus 1106 to a display interface 1116 configured to connect the computing device 1100 to a display device 1118. The display device 1118 may include a display screen that is a built-in component of the computing device 1100. The display device 1118 may also include a computer monitor, television, or projector, among others, that is internal to or externally connected to the computing device 1100.

The computing device 1100 also includes a storage device 1120. The storage device 0 is a physical memory such as a floppy disk drive, a hard drive, compact disk drives, Blu-ray disk drives, redundant array of independent disks (RAID) systems, and digital versatile disk (DVD) drives, an optical drive, a thumbdrive, an array of drives, a solid-state drive, or any combinations thereof. The storage device 1120 may also include remote storage drives.

The computing device 1100 may also include a network interface controller (NIC) 1122. The NIC 1122 may be implemented by any type of interface standard, such as an Ethernet interface, a universal serial bus (USB), a Bluetooth® interface, a near field communication (NFC) interface, and/or a PCI express interface. The NIC 1122 may be configured to connect the computing device 1100 through the bus 1106 to a network 1124. The network 1124 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The NIC 1122 of the illustrated example also includes a communication device such as a transmitter, a receiver, a transceiver, a modem, a residential gateway, a wireless access point, and/or a network interface to facilitate exchange of data with external machines (e.g., computing devices of any kind) via the network 1124. The communication can be via, for example, an Ethernet connection, a digital subscriber line (DSL) connection, a telephone line connection, a coaxial cable system, a satellite system, a line-of-site wireless system, a cellular telephone system, etc.

The computing device 1100 further includes a camera 1126. For example, the camera 1126 may include one or more imaging sensors. In some example, the camera 1126 may include a processor to generate video frames.

The computing device 1100 further includes the example image compressor 102 of FIG. 1. For example, the image compressor 102 can be used to compress images using autoencoder information. The image compressor 102 can include the example scaling controller 108, the example pre-compressor 110, the example residual determiner 112, the example autoencoder(s) 114, the example bitstream merger 116, and the example compressor database 118. In some examples, the scaling controller 108, the pre-compressor 110, residual determiner 112, autoencoder(s) 114, the bitstream merger 116, and the compressor database 118 of the image compressor 102 may be a microcontroller, embedded processor, or software module.

The computing device 1100 also further includes the example image decompressor 104 of FIG. 1. For example, the image decompressor 104 can decompress images or video streams compressed using autoencoder information. As one examples, the image decompressor 104 can decompress images using the instructions 1000 of FIG. 10. The example image decompressor 104 can include the example data parser 120, the example decompressor 122, the example scaling controller 124, the example decoder(s) 126, the example reconstructor 128, and the example decompressor database 130. In some examples, the data parser 120, the decompressor 122, the scaling controller 124, the decoder(s) 126, the reconstructor 128, and the decompressor database 130 of the image decompressor 104 may be a microcontroller, embedded processor, or software module.

The block diagram of FIG. 11 is not intended to indicate that the computing device 1100 is to include all of the components shown in FIG. 11. Rather, the computing device 1100 can include fewer or additional components not illustrated in FIG. 11, such as additional buffers, additional processors, and the like. The computing device 1100 may include any number of additional components not shown in FIG. 11, depending on the details of the specific implementation. Furthermore, any of the functionalities of the scaling controller 108, the pre-compressor 110, the residual determiner 112, the autoencoder(s) 114, the bitstream merger 116, the data parser 120, the decompressor 122, the scaling controller 124, the decoder(s) 126, and/or the reconstructor 128, may be partially, or entirely, implemented in hardware and/or in the CPU 1102. For example, the functionality may be implemented with an application specific integrated circuit, in logic implemented in the CPU 1102, or in any other device. In addition, any of the functionalities of the CPU 1102 may be partially, or entirely, implemented in hardware and/or in a processor. For example, the functionality of the image compressor 102 and/or the image decompressor 104 may be implemented with an application specific integrated circuit, in logic implemented in a processor, in logic implemented in a specialized graphics processing unit such as the GPU 1108, or in any other device.

FIG. 12 is a block diagram showing computer readable media 1200 that store code for compressing and decompressing images. The computer readable media 1200 may be accessed by a processor 1202 over a computer bus 1204. Furthermore, the computer readable medium 1200 may include code configured to direct the processor 1202 to perform the methods described herein (e.g., the instructions 900 of FIG. 9 and/or the instructions 1000 of FIG. 10). In some examples, the computer readable media 1200 may be non-transitory computer readable media. In some examples, the computer readable media 1200 may be storage media.

The various software components discussed herein may be stored on one or more computer readable media 1200, as indicated in FIG. 12. For example, a scaling module 1205 may be configured to upscale and/or downscale an input image using a scale factor. A pre-compressor module 1206 may be configured to compress an input scaled image to generate a fundamental bitstream and reconstructed scaled image. A residual determiner module 1207 may be configured to determine a residual between the input image and the reconstructed scaled image. An autoencoder module 1208 may be configured to encode a residual of the reconstructed scaled image and a raw image to generate side information. A bitstream merger module 1210 may be configured to combine the fundamental bitstream and the side information to generate an output compressed bitstream. A data parser module 1212 may be configured to parse the output compressed bitstream to separate the output compressed bitstream into a fundamental bitstream and a side information bitstream. A decompressor module 1214 may be configured to decompress the fundamental bitstream to generate a scaled image. A scaling module 1216 may be configured to upscale the scaled image to generate a base image. A decoder module 1218 may be configured to decode the side information bitstream to generate auxiliary information. A reconstructor module 1220 may be configured to combine the base image and the auxiliary information to generate a reconstructed image for target machine learning tasks.

The block diagram of FIG. 12 is not intended to indicate that the computer readable media 1200 is to include all of the components shown in FIG. 12. Further, the computer readable media 1200 may include any number of additional components not shown in FIG. 12, depending on the details of the specific implementation.

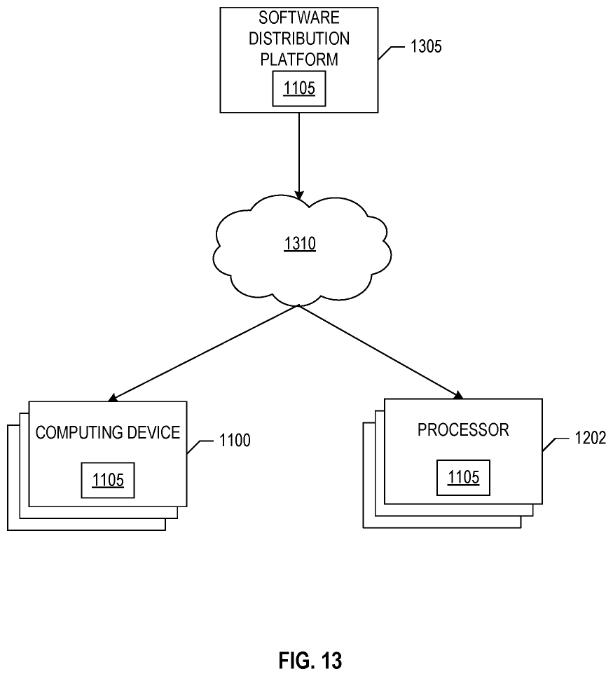

A block diagram illustrating an example software distribution platform 1305 to distribute software such as the example computer readable instructions 1105 of FIG. 11 to third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1105 of FIG. 11. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the computer readable instructions 1105, which may correspond to the example machine readable instructions 900, 1000 of FIGS. 9-10, as described above. The one or more servers of the example software distribution platform 1305 are in communication with a network 1310, which may correspond to any one or more of the Internet and/or any of the example network 1124 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1105 from the software distribution platform 1305. For example, the software, which may correspond to the example computer readable instructions 1105 of FIG. 11, may be downloaded to the example computing device 1100 and/or the example processor 1202, which is to execute the computer readable instructions 1105 to implement the example image compressor 102 and/or the example image decompressor 104 of FIG. 1. In some example, one or more servers of the software distribution platform 1305 periodically offer, transmit, and/or force updates to the software (e.g., the example computer readable instructions 1105 of FIG. 11) to ensure improvements, patches, updates, etc. are distributed and applied to the software at the end user devices.

From the foregoing, it will be appreciated that example methods, apparatus and articles of manufacture have been disclosed for image compression using autoencoder information. For example, methods, apparatus, and articles of manufacture improve the performance of target machine learning tasks (e.g., super resolution, object detection, etc.). The disclosed methods, apparatus and articles of manufacture improve the efficiency of using a computing device by selecting one or more autoencoders based on the target machine learning task. For example, if the target machine learning task is object detection, examples disclosed herein compress images and/or video frames using an object-detection enhanced autoencoder and not a super resolution based autoencoder. The disclosed methods, apparatus and articles of manufacture are accordingly directed to one or more improvement(s) in the functioning of a computer.

Example methods, apparatus, systems, and articles of manufacture for image compression using autoencoder information are disclosed herein. Further examples and combinations thereof include the following:

Example 1 includes an apparatus comprising a pre-compressor to compress an input scaled image to generate a fundamental bitstream and a reconstructed scaled image, an autoencoder to encode a residual of a reconstructed image to generate a side information bitstream, the reconstructed image based on the reconstructed scaled image, and a bitstream merger to combine the fundamental bitstream and the side information bitstream to generate an output compressed bitstream.

Example 2 includes the apparatus of example 1, further including a scaling controller to downscale an input image based on a scale factor to generate the input scaled image.

Example 3 includes the apparatus of example 2, wherein the scaling controller is to upscale the reconstructed scaled image based on the scale factor to generate the reconstructed image.

Example 4 includes the apparatus of example 3, further including a residual determiner to determine the residual of the reconstructed image based on a difference between the input image and the reconstructed image.

Example 5 includes the apparatus of example 1, wherein the autoencoder is to perform at least one of super resolution, object detection, anomaly detection, or event search.

Example 6 includes the apparatus of example 1, wherein the autoencoder is a first autoencoder and the side information bitstream is a first side information bitstream, and further including a second autoencoder to encode the residual of the reconstructed image to generate a second side information bitstream.

Example 7 includes the apparatus of example 6, wherein the first autoencoder is to perform object detection and the second autoencoder is to perform event search.

Example 8 includes the apparatus of example 6, wherein the output compressed bitstream is to include the second side information bitstream.

Example 9 includes a non-transitory computer readable medium comprising instructions which, when executed, cause a machine to at least compress an input scaled image to generate a fundamental bitstream and a reconstructed scaled image, encode a residual of a reconstructed image to generate a side information bitstream, the reconstructed image based on the reconstructed scaled image, and combine the fundamental bitstream and the side information bitstream to generate an output compressed bitstream.

Example 10 includes the non-transitory computer readable medium of example 9, wherein the instructions cause the machine to downscale an input image based on a scale factor to generate the input scaled image.

Example 11 includes the non-transitory computer readable medium of example 10, wherein the instructions cause the machine to upscale the reconstructed scaled image based on the scale factor to generate the reconstructed image.

Example 12 includes the non-transitory computer readable medium of example 11, wherein the instructions cause the machine to determine the residual of the reconstructed image based on a difference between the input image and the reconstructed image.

Example 13 includes the non-transitory computer readable medium of example 9, wherein the instructions cause the machine to perform at least one of super resolution, object detection, anomaly detection, or event search.

Example 14 includes the non-transitory computer readable medium of example 9, wherein the side information bitstream is a first side information bitstream, and the instructions cause the machine to encode the residual of the reconstructed image to generate a second side information bitstream.

Example 15 includes the non-transitory computer readable medium of example 14, wherein the instructions cause the machine to perform object detection and event search.

Example 16 includes the non-transitory computer readable medium of example 14, wherein the output compressed bitstream is to include the second side information bitstream.

Example 17 includes a method comprising compressing an input scaled image to generate a fundamental bitstream and a reconstructed scaled image, encoding a residual of a reconstructed image to generate a side information bitstream, the reconstructed image based on the reconstructed scaled image, and combining the fundamental bitstream and the side information bitstream to generate an output compressed bitstream.

Example 18 includes the method of example 17, further including downscaling an input image based on a scale factor to generate the input scaled image.

Example 19 includes the method of example 18, further including upscaling the reconstructed scaled image based on the scale factor to generate the reconstructed image.

Example 20 includes the method of example 19, further including determining the residual of the reconstructed image based on a difference between the input image and the reconstructed image.

Example 21 includes the method of example 17, further including performing at least one of super resolution, object detection, anomaly detection, or event search.

Example 22 includes the method of example 17, wherein the side information bitstream is a first side information bitstream, and further including encoding the residual of the reconstructed image to generate a second side information bitstream.

Example 23 includes the method of example 22, further including performing object detection and event search.

Example 24 includes the method of example 22, wherein the output compressed bitstream is to include the second side information bitstream.

Example 25 includes an apparatus comprising a data parser to separate an input bitstream into a fundamental bitstream and a side information bitstream, a decoder to decode the side information bitstream to generate auxiliary information, and a reconstructor to combine a base image and the auxiliary information to generate a reconstructed image.

Example 26 includes the apparatus of example 25, wherein the data parser is to identify the fundamental bitstream based on a first flag and identify the side information bitstream based on a second flag.

Example 27 includes the apparatus of example 25, wherein the data parser is to identify the fundamental bitstream based on a first data format and identify the side information bitstream based on a second data format.

Example 28 includes the apparatus of example 25, further including a decompressor to decompress the fundamental bitstream to generate a scaled image.

Example 29 includes the apparatus of example 28, further including a scaling controller to upscale the scaled image to generate the base image based on a scale factor.

Example 30 includes the apparatus of example 25, wherein the decoder is a first decoder and the auxiliary information is first auxiliary information, and further including a second decoder to decode the side information to generate second auxiliary information.

Example 31 includes the apparatus of example 30, wherein the reconstructed image is to include the second auxiliary information.

Example 32 includes the apparatus of example 31, wherein the first auxiliary information corresponds to a first machine learning task and the second auxiliary information corresponds to a second machine learning task.

Example 33 includes a non-transitory computer readable medium comprising instructions which, when executed, cause a machine to at least separate an input bitstream into a fundamental bitstream and a side information bitstream, decode the side information bitstream to generate auxiliary information, and combine a base image and the auxiliary information to generate a reconstructed image.

Example 34 includes the non-transitory computer readable medium of example 33, wherein the instructions cause the machine to identify the fundamental bitstream based on a first flag and identify the side information bitstream based on a second flag.

Example 35 includes the non-transitory computer readable medium of example 33, wherein the instructions cause the machine to identify the fundamental bitstream based on a first data format and identify the side information bitstream based on a second data format.

Example 36 includes the non-transitory computer readable medium of example 33, wherein the instructions cause the machine to decompress the fundamental bitstream to generate a scaled image.

Example 37 includes the non-transitory computer readable medium of example 36, wherein the instructions cause the machine to upscale the scaled image to generate the base image based on a scale factor.

Example 38 includes the non-transitory computer readable medium of example 33, wherein the auxiliary information is first auxiliary information, and the instructions cause the machine to decode the side information to generate second auxiliary information.

Example 39 includes the non-transitory computer readable medium of example 38, wherein reconstructed image is to include the second auxiliary information.

Example 40 includes the non-transitory computer readable medium of example 39, wherein the first auxiliary information corresponds to a first machine learning task and the second auxiliary information corresponds to a second machine learning task.

Example 41 includes a method comprising separating an input bitstream into a fundamental bitstream and a side information bitstream, decoding the side information bitstream to generate auxiliary information, and combining a base image and the auxiliary information to generate a reconstructed image.

Example 42 includes the method of example 41, further including identifying the fundamental bitstream based on a first flag and identify the side information bitstream based on a second flag.

Example 43 includes the method of example 41, further including identifying the fundamental bitstream based on a first data format and identify the side information bitstream based on a second data format.

Example 44 includes the method of example 41, further including decompressing the fundamental bitstream to generate a scaled image.

Example 45 includes the method of example 44, further including upscaling the scaled image to generate the base image based on a scale factor.

Example 46 includes the method of example 41, wherein the auxiliary information is first auxiliary information, and further including decoding the side information to generate second auxiliary information.

Example 47 includes the method of example 46, wherein the reconstructed image is to include the second auxiliary information.

Example 48 includes the method of example 47, wherein the first auxiliary information corresponds to a first machine learning task and the second auxiliary information corresponds to a second machine learning task.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
a pre-compressor to compress an input scaled image to generate a fundamental bitstream and a reconstructed scaled image;
an autoencoder to encode a residual of a reconstructed image to generate a side information bitstream, the reconstructed image based on the reconstructed scaled image; and
a bitstream merger to combine the fundamental bitstream and the side information bitstream to generate an output compressed bitstream.

2. The apparatus of claim 1, further including a scaling controller to downscale an input image based on a scale factor to generate the input scaled image.

3. The apparatus of claim 2, wherein the scaling controller is to upscale the reconstructed scaled image based on the scale factor to generate the reconstructed image.

4. The apparatus of claim 3, further including a residual determiner to determine the residual of the reconstructed image based on a difference between the input image and the reconstructed image.

5. The apparatus of claim 1, wherein the autoencoder is to perform at least one of super resolution, object detection, anomaly detection, or event search.

6. The apparatus of claim 1, wherein the autoencoder is a first autoencoder and the side information bitstream is a first side information bitstream, and further including a second autoencoder to encode the residual of the reconstructed image to generate a second side information bitstream.

7. The apparatus of claim 6, wherein the first autoencoder is to perform object detection and the second autoencoder is to perform event search.

8. The apparatus of claim 6, wherein the output compressed bitstream is to include the second side information bitstream.

9. A non-transitory computer readable medium comprising instructions which, when executed, cause a machine to at least:
compress an input scaled image to generate a fundamental bitstream and a reconstructed scaled image;
encode a residual of a reconstructed image to generate a side information bitstream, the reconstructed image based on the reconstructed scaled image; and
combine the fundamental bitstream and the side information bitstream to generate an output compressed bitstream.

10. The non-transitory computer readable medium of claim 9, wherein the instructions cause the machine to downscale an input image based on a scale factor to generate the input scaled image.

11. The non-transitory computer readable medium of claim 10, wherein the instructions cause the machine to upscale the reconstructed scaled image based on the scale factor to generate the reconstructed image.

12. The non-transitory computer readable medium of claim 11, wherein the instructions cause the machine to determine the residual of the reconstructed image based on a difference between the input image and the reconstructed image.

13. The non-transitory computer readable medium of claim 9, wherein the instructions cause the machine to perform at least one of super resolution, object detection, anomaly detection, or event search.

14. The non-transitory computer readable medium of claim 9, wherein the side information bitstream is a first side information bitstream, and the instructions cause the machine to encode the residual of the reconstructed image to generate a second side information bitstream.

15. The non-transitory computer readable medium of claim 14, wherein the instructions cause the machine to perform object detection and event search.

16. The non-transitory computer readable medium of claim 14, wherein the output compressed bitstream is to include the second side information bitstream.

17. A method comprising:
compressing an input scaled image to generate a fundamental bitstream and a reconstructed scaled image;
encoding a residual of a reconstructed image to generate a side information bitstream, the reconstructed image based on the reconstructed scaled image; and
combining the fundamental bitstream and the side information bitstream to generate an output compressed bitstream.

18. The method of claim 17, further including downscaling an input image based on a scale factor to generate the input scaled image.

19. The method of claim 18, further including upscaling the reconstructed scaled image based on the scale factor to generate the reconstructed image.

20. The method of claim 19, further including determining the residual of the reconstructed image based on a difference between the input image and the reconstructed image.

21. The method of claim 17, further including performing at least one of super resolution, object detection, anomaly detection, or event search.

22. The method of claim 17, wherein the side information bitstream is a first side information bitstream, and further including encoding the residual of the reconstructed image to generate a second side information bitstream.

23. The method of claim 22, further including performing object detection and event search.

24. The method of claim 22, wherein the output compressed bitstream is to include the second side information bitstream.

25.-48. (canceled)
